(19) United States
(12) Patent Application Publication
(10) Pub. No.: US 2026/0232008 A1
(43) Pub. Date: Aug. 13, 2026

(54) CARTRIDGE COMPRISING A PLURALITY OF AEROSOL-GENERATING GRANULES

(71) Applicant: Philip Morris Products S.A., Neuchatel (CH)

(72) Inventor: Rui Nuno Rodrigues Alves BATISTA, Morges (CH)

(73) Assignee: Philip Morris Products S.A., Neuchatel (CH)

(21) Appl. No.: 19/475,238

(22) PCT Filed: Apr. 19, 2024
(86) PCT No.: PCT/EP2024/060823

§ 371 Date: Oct. 14, 2025

(30) Foreign Application Priority Data
Apr. 21, 2023 (EP) 23169314.4

(51) Int. Cl. A24B 15/167; A24F 7/00; A24F 40/10; A24F 40/42; A24F 40/46; A24F 40/465; H05B 3/46

(52) U.S. Cl. CPC A24B 15/167; A24F 7/00; A24F 40/10; A24F 40/42; A24F 40/46; A24F 40/465; H05B 3/46

(57) ABSTRACT

A cartridge for an aerosol-generating system is provided, the cartridge including: a compartment containing a first aerosol-generating substrate, the first aerosol-generating substrate being a liquid or a gel; and a plurality of aerosol-generating granules, the plurality of aerosol-generating granules including a porous carrier medium defining a plurality of pores and a second aerosol-generating substrate releasably retained within the pores of the porous carrier medium, the second aerosol-generating substrate being a liquid or a gel including a flavourant and an aerosol former, the compartment further containing the plurality of aerosol-generating granules, and some or all of the plurality of aerosol-generating granules being dispersed in the first aerosol-generating substrate.

The invention relates to a cartridge comprising a plurality of aerosol-generating granules for use in an aerosol-generating system. The invention also relates to an aerosol-generating system comprising the cartridge and an aerosol-generating device configured to heat the cartridge.

Aerosol-generating systems for delivering nicotine to a user that comprise an atomiser configured to generate an inhalable aerosol from a nicotine-containing substrate are known.

Handheld electrically operated aerosol-generating systems comprising a cartridge comprising a storage portion containing a supply of liquid nicotine formulation and an electrically operated heater configured to heat the liquid nicotine formulation to generate an inhalable aerosol are known. Such known handheld electrically operated aerosol-generating systems also comprise an aerosol-generating device comprising control circuitry and a power source for supplying power to the electrically operated heater.

The electrically operated heater typically comprises a coil of electrically conductive wire that is wound around an elongate wick, which transports liquid nicotine formulation from the storage portion of the cartridge to the coil of wire. In use, an electric current may be passed through the coil of wire to heat the liquid nicotine formulation to generate an aerosol.

In other known handheld electrically operated aerosol-generating systems the heater comprises a fluid permeable heating element comprising an electrically conductive mesh that is in contact with a transport material, which conveys liquid nicotine formulation from the storage portion to the electrically conductive mesh. In use, an electric current may be passed through the electrically conductive mesh to heat the liquid nicotine formulation to generate an aerosol.

A cartridge containing a supply of liquid nicotine formulation and an atomiser configured to generate an aerosol from the liquid nicotine formulation is sometimes referred to as a “cartomiser”. The cartridge typically also comprises a mouthpiece portion that a user draws on, in use, in order to inhale the generated aerosol.

Handheld electrically operated aerosol-generating systems comprising gel nicotine formulations are also known.

Liquid and gel formulations for use in aerosol-generating systems typically comprise one or more aerosol formers, such as glycerine and propylene glycol, and optionally water. Liquid and gel formulations for use in aerosol-generating systems typically also comprise one or more flavourants. However, such flavourants may chemically interact with other components of the liquid or gel formulation. This may lead to progressive chemical degradation over time of one or more components of the liquid or gel formulation. Such progressive chemical degradation may negatively impact the overall performance of a cartridge containing the liquid or gel formulation. This may disadvantageously reduce the shelf-life of the cartridge. For example, progressive chemical degradation over time of one or more flavourants in a liquid or gel formulation may negatively impact the perceived taste of the inhalable aerosol generated by a cartridge containing the liquid or gel formulation.

Flavourants in a liquid or gel formulation may evaporate, migrate, or sublimate over time. Evaporation, migration, and sublimation of flavourants may be exacerbated by high environmental temperatures and humidities. Loss of flavourants during storage through evaporation, migration, or sublimation may negatively impact the overall performance of a cartridge containing the liquid or gel formulation. This may disadvantageously reduce the shelf-life of the cartridge. For example, evaporation, migration, and sublimation over time of one or more flavourants in a liquid or gel formulation may negatively impact the perceived taste of the inhalable aerosol generated by a cartridge containing the liquid or gel formulation.

Cartridges containing liquid or gel formulations may be prone to leakage of the liquid or gel formulation during storage, handling and use thereof. Leakage of the liquid or gel formulation may be exacerbated by high environmental temperatures and humidities. Loss of liquid or gel formulation from a cartridge through leakage may disadvantageously reduce the lifespan of the cartridge. Leakage of liquid or gel formulation from a cartridge may negatively impact the overall performance of the cartridge. For example, leakage of liquid or gel formulation from a cartridge may negatively impact the consistency of the inhalable aerosol generated by the cartridge. Leakage of liquid or gel formulation from a cartridge may disadvantageously damage or impair the function of other components of an aerosol-generating system comprising the cartridge. For example, leakage of liquid or gel formulation from a cartridge may disadvantageously damage or impair the function of an aerosol-generating device.

In aerosol-generating systems comprising a cartridge containing a liquid or gel formulation, there may be a short delay following actuation of the heater before the liquid or gel formulation is heated to a sufficient temperature to generate aerosol. This may result in poor aerosol generation and delivery at the beginning of the user experience. As the user experience continues, the liquid or gel formulation in the cartridge is gradually depleted. Depletion of the liquid or gel formulation may result in poor aerosol generation and delivery at the end of the user experience. Consequently, the aerosol generation and delivery in aerosol-generating systems comprising a cartridge containing a liquid or gel formulation may disadvantageously be inconsistent across the user experience.

It would be desirable to provide a cartridge comprising a liquid or gel aerosol-generating substrate in which chemical degradation over time of one or more components of the aerosol-generating substrate is prevented or reduced compared to known cartridges.

It would be desirable to provide a cartridge comprising a liquid or gel aerosol-generating substrate in which evaporation, migration, or sublimation over time of one or more components of the aerosol-generating substrate is prevented or reduced compared to known cartridges.

It would be desirable to provide a cartridge comprising a liquid or gel aerosol-generating substrate in which leakage of aerosol-generating substrate during storage, handling and use of the cartridge is prevented or reduced compared to known cartridges.

It would be desirable to provide a cartridge comprising a liquid or gel aerosol-generating substrate that allows for more consistent aerosol generation and delivery to a user compared to known cartridges.

The invention relates to a cartridge for an aerosol-generating system. The cartridge may comprise a compartment. The compartment may contain a first aerosol-generating substrate. The first aerosol-generating substrate may be a liquid or a gel. The cartridge may comprise a plurality of aerosol-generating granules. The plurality of aerosol-generating granules may comprise a porous carrier medium defining a plurality of pores. A second aerosol-generating substrate may be releasably retained within the pores of the porous carrier medium. The second aerosol-generating substrate may be a liquid or a gel. The second aerosol-generating substrate may comprise a flavourant and an aerosol former.

The invention relates to an aerosol-generating system. The aerosol-generating system may comprise a cartridge. The aerosol-generating system may comprise an aerosol-generating device. The cartridge may comprise a compartment. The compartment may contain a first aerosol-generating substrate. The first aerosol-generating substrate may be a liquid or a gel. The cartridge may comprise a plurality of aerosol-generating granules. The plurality of aerosol-generating granules may comprise a porous carrier medium defining a plurality of pores. A second aerosol-generating substrate may be releasably retained within the pores of the porous carrier medium. The second aerosol-generating substrate may be a liquid or a gel. The second aerosol-generating substrate may comprise a flavourant and an aerosol former. The aerosol-generating device may be configured to heat the first aerosol-generating substrate of the cartridge. The aerosol-generating device may be configured to heat the second aerosol-generating substrate of the cartridge.

According to a first aspect of the invention there is provided a cartridge for an aerosol-generating system, the cartridge comprising: a compartment containing a first aerosol-generating substrate, wherein the first aerosol-generating substrate is a liquid or a gel; and a plurality of aerosol-generating granules, wherein the plurality of aerosol-generating granules comprise a porous carrier medium defining a plurality of pores and a second aerosol-generating substrate releasably retained within the pores of the porous carrier medium, wherein the second aerosol-generating substrate is a liquid or a gel comprising a flavourant and an aerosol former.

According to a second aspect of the invention there is also provided an aerosol-generating system comprising: a cartridge according to the first aspect of the invention; and an aerosol-generating device configured to heat the first aerosol-generating substrate and the second aerosol-generating substrate of the cartridge.

Cartridges according to the first aspect of the invention comprise a first aerosol-generating substrate and a plurality of aerosol-generating granules comprising a second aerosol-generating substrate releasably retained within the pores of a porous carrier medium. The second aerosol-generating material is immobilised within the pores of the porous carrier medium until the plurality of aerosol-generated granules are heated during use of the cartridge to a sufficient temperature to aerosolize the second aerosol-generating substrate.

Advantageously, the physical and mechanical stability of the immobilized second aerosol-generating substrate within the pores of the porous carrier medium may be maintained upon exposure of the cartridge to external forces during storage and handling of the cartridge. For example, upon exposure of the cartridge to impact forces due to dropping and centrifugal forces due to shaking.

Advantageously, the physical and mechanical stability of the immobilized second aerosol-generating substrate within the pores of the porous carrier medium may be maintained upon exposure of the cartridge to high environmental temperatures and humidities. For example, where the second aerosol-generating substrate is a gel, the second aerosol-generating substrate may remain immobilized within the pores of the porous carrier medium when in a liquid state. This may advantageously reduce the impact of environmental conditions on the performance of cartridges according to the first aspect of the invention compared to known cartridges.

Providing a plurality of aerosol-generating granules comprising a second aerosol-generating substrate releasably retained within the pores of a porous carrier medium may prevent or reduce contact between the second aerosol-generating substrate and the first aerosol-generating substrate. This may prevent or reduce chemical interactions between components of the first aerosol-generating substrate and components of the second aerosol-generating substrate during storage. Advantageously, this may prevent or reduce progressive chemical degradation of components of the first aerosol-generating substrate and components the second aerosol-generating substrate over time. This may advantageously increase the shelf-life of cartridges according to the first aspect of the invention compared to known cartridges.

Preventing or reducing progressive chemical degradation of components of the first aerosol-generating substrate and components the second aerosol-generating substrate over time may advantageously improve the perceived quality and consistency of the inhalable aerosol generated by cartridges according to the first aspect of the invention compared to known cartridges. For example, preventing or reducing progressive chemical degradation over time of the flavourant in the second aerosol-generating substrate may advantageously improve the perceived taste of the inhalable aerosol generated by cartridges according to the first aspect of the invention compared to known cartridges.

Providing a plurality of aerosol-generating granules comprising a second aerosol-generating substrate releasably retained within the pores of a porous carrier medium may advantageously reduce or prevent evaporation, migration or sublimation over time of the flavourant in the second aerosol-generating substrate. This may advantageously increase the shelf-life of cartridges according to the first aspect of the invention compared to known cartridges.

Preventing or reducing evaporation, migration or sublimation over time of the flavourant in the second aerosol-generating substrate over time may advantageously improve the perceived quality and consistency of the inhalable aerosol generated by cartridges according to the first aspect of the invention compared to known cartridges. For example, preventing or reducing evaporation, migration or sublimation of the flavourant in the second aerosol-generating substrate may advantageously improve the perceived taste of the inhalable aerosol generated by cartridges according to the first aspect of the invention compared to known cartridges.

Providing a plurality of aerosol-generating granules comprising a second aerosol-generating substrate releasably retained within the pores of a porous carrier medium may advantageously reduce or prevent leakage of the second aerosol-generating substrate during storage, handling and use of cartridges according to the first aspect of the invention. This may increase the lifespan of cartridges according to the invention compared to known cartridges compared to known cartridges.

Reducing or preventing leakage of the second aerosol-generating substrate during storage, handling and use may advantageously improve the consistency of the inhalable aerosol generated by cartridges according to the first aspect of the invention compared to known cartridges. Reducing or preventing leakage of the second aerosol-generating substrate during storage, handling and use of cartridges according to the first aspect of the invention may advantageously reduce or prevent damage to other components of aerosol-generating systems according to the second aspect of the invention.

Providing a plurality of aerosol-generating granules comprising a second aerosol-generating substrate releasably retained within the pores of a porous carrier medium, may advantageously facilitate provision of a first aerosol-generating substrate and a second aerosol-generating substrate having different aerosolization temperatures. The aerosolization temperature of the second aerosol-generating substrate may be lower than the aerosolization temperature of the first aerosol-generating substrate. As a result, during use of the cartridge the second aerosol-generating substrate may be heated to a sufficient temperature to generate aerosol earlier in the user experience than the first aerosol-generating substrate. This may result in improved aerosol generation and delivery at the beginning of the user experience. Alternatively, the aerosolization temperature of the second aerosol-generating substrate may be higher than the aerosolization temperature of the first aerosol-generating substrate. As a result, during use of the cartridge the second aerosol-generating substrate may be heated to a sufficient temperature to generate aerosol later in the user experience than the first aerosol-generating substrate and may continue to generate aerosol after the first aerosol-generating substrate has been depleted. This may result in improved aerosol generation and delivery at the end of the user experience. Provision of a cartridge comprising a first aerosol-generating substrate and a plurality of aerosol-generating granules comprising a second aerosol-generating substrate releasably retained within the pores of a porous carrier medium may thereby advantageously allow for more consistent aerosol generation and delivery to a user compared to known cartridges. Advantageously, cartridges according to the first aspect of the invention may be manufactured using existing production equipment. Advantageously, cartridges according to the first aspect of the invention may be manufactured at comparable cost to known cartridges.

As used herein, the term “aerosol-generating substrate” is used to describe a substrate comprising aerosol-generating material that is capable of releasing upon heating volatile compounds that can generate an aerosol.

As used herein, the term “aerosol” is used to describe a dispersion of solid particles, or liquid droplets, or a combination of solid particles and liquid droplets, in a gas. The aerosol may be visible or invisible. The aerosol may include vapours of substances that are ordinarily liquid or solid at room temperature as well as solid particles, or liquid droplets, or a combination of solid particles and liquid droplets.

As used herein, the term “aerosolization temperature” is used to describe the lowest temperature at which a measurable amount of aerosol is released from an aerosol-generating substrate.

As used herein, the term “aerosol-generating device” is used to describe a device that interacts with an aerosol-generating substrate to generate an aerosol. In particular, the term “aerosol-generating device” is used to describe a device that heats an aerosol-generating substrate to generate an aerosol.

As used herein, the term “gel” is used to describe a substantially dilute cross-linked material, which exhibits no flow in the steady state.

As used herein, the terms “proximal”, “distal”, “upstream” and “downstream” are used to describe the relative positions of components, or portions of components, of cartridges according to the first aspect of the invention and aerosol-generating systems according to the second aspect of the invention.

The cartridge comprises a proximal end through which, in use, an aerosol exits the cartridge. The cartridge comprises a distal end opposite the proximal end. The proximal end of the cartridge may also be referred to as the downstream end. The distal end of the cartridge may also be referred to as the upstream end. Components, or portions of components, of the cartridge may be described as being upstream or downstream of one another based on their relative positions between the proximal or downstream end and the distal or upstream end of the cartridge.

As used herein, the term “longitudinal” is used to describe the direction between the proximal end and the opposed distal end of the cartridge or aerosol-generating system and the term “transverse” is used to describe the direction perpendicular to the longitudinal direction.

As used herein, the term “length” is used to describe the maximum longitudinal dimension of components, or portions of components, of the cartridge or aerosol-generating system parallel to the longitudinal axis between the proximal end and the opposed distal end of the cartridge or aerosol-generating system.

As used herein, the terms “height” and “width” are used to describe the maximum transverse dimensions of components, or portions of components, of the cartridge or aerosol-generating system perpendicular to the longitudinal axis of the cartridge or aerosol-generating system. Where the height and width of components, or portions of components, of the cartridge or aerosol-generating system are not the same, the term “width” is used to refer to the larger of the two transverse dimensions perpendicular to the longitudinal axis of the cartridge or aerosol-generating system.

Unless otherwise stated, properties of aerosol-generating substrates recited herein are those prior to use of the cartridge.

Unless otherwise stated, percentages by weight of components of an aerosol-generating substrate recited herein are based on the total weight of the aerosol-generating substrate.

Unless otherwise stated, as used herein, the term “cross-section” refers to the transverse cross-section.

The first aerosol-generating substrate may be a liquid aerosol-generating substrate.

The first aerosol-generating substrate may be a gel aerosol-generating substrate.

Advantageously, the first aerosol-generating substrate may comprise nicotine.

As used herein, the term “nicotine” is used to describe nicotine, a nicotine base or a nicotine salt.

The first aerosol-generating substrate may be a liquid nicotine formulation.

As used herein, the term “liquid nicotine formulation” describes a liquid formulation comprising nicotine.

The first aerosol-generating substrate may be a gel nicotine formulation.

As used herein, the term “gel nicotine formulation” describes a gel formulation comprising nicotine.

The first aerosol-generating substrate may comprise natural nicotine.

The first aerosol-generating substrate may comprise synthetic nicotine.

The first aerosol-generating substrate may have a nicotine content of greater than or equal to 0.5 percent by weight, greater than or equal to 1 percent by weight, or greater than or equal to 1.5 percent by weight.

The first aerosol-generating substrate may have a nicotine content of less than or equal to 10 percent by weight, less than or equal to 5 percent by weight, or less than or equal to 3 percent by weight.

The first aerosol-generating substrate may have a nicotine content of between 0.5 percent by weight and 10 percent by weight. For example, the first aerosol-generating substrate may have a nicotine content of between 0.5 percent by weight and 5 percent by weight or between 0.5 percent by weight and 3 percent by weight.

The first aerosol-generating substrate may have a nicotine content of between 1 percent by weight and 10 percent by weight. For example, the first aerosol-generating substrate may have a nicotine content of between 1 percent by weight and 5 percent by weight or between 1 percent by weight and 3 percent by weight.

The first aerosol-generating substrate may have a nicotine content of between 1.5 percent by weight and 10 percent by weight. For example, the first aerosol-generating substrate may have a nicotine content of between 1.5 percent by weight and 5 percent by weight or between 1.5 percent by weight and 3 percent by weight.

For example, the first aerosol-generating substrate may have a nicotine content of 2 percent by weight.

Advantageously, the first aerosol-generating substrate may comprise an aerosol former.

Advantageously, the first aerosol-generating substrate may comprise nicotine and an aerosol former.

The aerosol former may be any suitable known compound or mixture of compounds that, in use, facilitates formation of a dense and stable aerosol. The aerosol former may be substantially resistant to thermal degradation at temperatures typically reached during use of an aerosol-generating system according to the second aspect of the invention.

Examples of suitable aerosol formers include, but are not limited to: polyhydric alcohols such as, for example, triethylene glycol, 1,3-butanediol, propylene glycol and glycerine; esters of polyhydric alcohols such as, for example, glycerol mono-, di- or triacetate; aliphatic esters of mono-, di- or polycarboxylic acids such as, for example, dimethyl dodecanedioate and dimethyl tetradecanedioate; and combinations thereof.

Advantageously, the aerosol former may comprise one or more polyhydric alcohols.

More advantageously, the aerosol former comprises one or more polyhydric alcohols selected from the group consisting of propylene glycol, triethylene glycol, 1,3-butanediol and glycerine.

The aerosol former may comprise one or both of glycerine and propylene glycol. The aerosol former may consist of glycerine. The aerosol former may consist of propylene glycol. The aerosol former may consist of a combination of glycerine and propylene glycol.

The first aerosol-generating substrate may comprise water.

The first aerosol-generating substrate may comprise a flavourant.

The first aerosol-generating substrate may comprise one or more flavourants.

The first aerosol-generating substrate may comprise one or more natural flavourants.

The first aerosol-generating substrate may comprise one or more synthetic flavourants.

The first aerosol-generating substrate may comprise any suitable flavourant. Suitable flavourants include, but are not limited to: menthol; peppermint oil; gamma octalactone; vanillin; ethyl vanillin; methyl salicylate; linalool; bergamot oil; geranium oil; ginger oil; and lemon oil.

The plurality of aerosol-generating granules comprise a porous carrier medium defining a plurality of pores and a second aerosol-generating substrate releasably retained within the pores of the porous carrier medium.

Unless otherwise stated, references to “aerosol-generating granules” herein refer to the combination of the porous carrier medium and the aerosol-generating substrate releasably retained within the pores of the porous carrier medium.

The porous carrier medium may be chemically inert. Advantageously, the porous carrier medium is chemically inert with respect to the aerosol-generating substrate releasably retained within the pores of the porous carrier medium. Where some or all of the plurality of aerosol-generating granules are in contact with the first aerosol-generating substrate, advantageously the porous carrier medium is chemically inert with respect to the aerosol-generating substrate releasably retained within the pores of the porous carrier medium.

The porous carrier medium may be substantially resistant to thermal degradation at temperatures typically reached during use of an aerosol-generating system comprising the cartridge. Advantageously, the porous carrier medium does not contribute to aerosol generated during use of an aerosol-generating system comprising the cartridge.

The porous carrier medium is coated, impregnated or otherwise loaded with the second aerosol-generating substrate such that the second aerosol-generating substrate is releasably retained within the pores of the porous carrier medium.

The porous carrier medium may be loaded with the second aerosol-generating substrate using existing methods known to a person skilled in the art.

Where the second aerosol-generating substrate is a liquid, a suitable method may comprise steps of: submerging the porous carrier medium in the second aerosol-generating substrate and soaking the porous carrier medium in the second aerosol-generating substrate until the second aerosol-generating substrate penetrates the pores of the porous carrier medium and is adsorbed onto the vesicular surface of the pores of the porous carrier medium.

The method may comprise stirring the porous carrier medium and the second aerosol-generating substrate.

The method may further comprise drying the porous carrier medium loaded with the second aerosol-generating substrate at a low temperature such as, for example, 50 degrees Celsius.

Where the second aerosol-generating substrate is a thermo-reversible gel, a suitable method may comprise steps of: heating the second aerosol-generating substrate to liquefy the second aerosol-generating substrate, submerging the porous carrier medium in the liquefied second aerosol-generating substrate, soaking the porous carrier medium in the liquified second aerosol-generating substrate until the liquified second aerosol-generating substrate penetrates the pores of the porous carrier medium and is adsorbed onto the vesicular surface of the pores of the porous carrier medium, and cooling the porous carrier medium loaded with the liquefied second aerosol-generating substrate.

The method may comprise stirring the porous carrier medium and the liquefied second aerosol-generating substrate.

The method may further comprise drying the porous carrier medium loaded with the liquefied second aerosol-generating substrate at low temperature such as, for example, 50 degrees Celsius.

The second aerosol-generating substrate may be loaded and retained within the plurality of pores of the porous carrier medium as a result of capillarity and surface tension phenomena.

The porous carrier medium may have a closed-cell structure. Where the porous carrier medium has a closed-cell structure, the aerosol-generating substrate releasably retained with the pores of the porous carrier medium may be loaded on an outer surface of the porous carrier medium.

The porous carrier medium may have an open-cell structure. Where the porous carrier medium has an open-cell structure, the aerosol-generating substrate releasably retained within with the pores of the porous carrier medium may be loaded within the open-cell structure of the porous carrier medium.

The porous carrier medium may be an inorganic porous carrier medium.

The porous carrier medium may comprise one or more of aluminium, calcium, iron, magnesium, and silicon.

The porous carrier medium may comprise one or both of a metal oxide and a metalloid oxide. For example, the porous carrier medium may comprise one or more of aluminium oxide, calcium oxide, iron oxide, magnesium oxide, and silicon dioxide.

The porous carrier medium may comprise a metal carbonate. For example, the porous carrier medium may comprise one or more of calcium carbonate and magnesium carbonate.

The porous carrier medium may comprise one or more of a metal oxide, a metalloid oxide and a metal carbonate. For example, the porous carrier medium may comprise one or more of aluminium oxide, calcium oxide, iron oxide, magnesium oxide, silicon dioxide, calcium carbonate, and magnesium carbonate.

The porous carrier medium may comprise one or both of a metal carbide and a metalloid carbide. For example, the porous carrier medium may comprise silicon carbide.

The porous carrier medium may comprise one or both of a metal nitride and a metalloid nitride. For example, the porous carrier medium may comprise silicon nitride.

Advantageously, the porous carrier medium may comprise silicon dioxide.

Advantageously, the porous carrier medium may comprise one or more of a ceramic, an igneous rock, and a sedimentary rock.

Advantageously, the porous carrier medium may comprise one or more of an igneous rock and a sedimentary rock.

The porous carrier medium may comprise an igneous rock. For example, the porous carrier medium may comprise one or more of basalt, pumice, and scoria.

The porous carrier medium may comprise a sedimentary rock. For example, the porous carrier medium may comprise one or more of expanded clay, limestone, and sandstone.

The porous carrier medium may comprise a ceramic. For example, the porous carrier medium may comprise one or more of a ceramic carbide, a ceramic nitride, a ceramic oxide, and a ceramic silicate.

The porous carrier medium may comprise a sintered ceramic.

The porosity of the porous carrier medium may be greater than or equal to 2 percent, greater than or equal to 5 percent, greater than or equal to 10 percent, greater than or equal to 20 percent, or greater than or equal to 30 percent.

The porosity of the porous carrier medium may be less than or equal to 85 percent, less than or equal to 70 percent, less than or equal to 60 percent, less than or equal to 50 percent or less than or equal to 40 percent.

The porosity of the porous carrier medium may be between 2 percent and 85 percent, between 2 percent and 70 percent, between 2 percent and 60 percent, between 2 percent and 50 percent, or between 2 percent and 40 percent.

The porosity of the porous carrier medium may be between 5 percent and 85 percent, between 5 percent and 70 percent, between 5 percent and 60 percent, between 5 percent and 50 percent, or between 5 percent and 40 percent.

The porosity of the porous carrier medium may be between 10 percent and 85 percent, between 10 percent and 70 percent, between 10 percent and 60 percent, between 10 percent and 50 percent, or between 10 percent and 40 percent.

The porosity of the porous carrier medium may be between 20 percent and 85 percent, between 20 percent and 70 percent, between 20 percent and 60 percent, between 20 percent and 50 percent, or between 20 percent and 40 percent.

The porosity of the porous carrier medium may be between 30 percent and 85 percent, between 30 percent and 70 percent, between 30 percent and 60 percent, between 30 percent and 50 percent, or between 30 percent and 40 percent.

For example, the porous carrier medium may comprise a ceramic having a porosity of between 30 percent and 70 percent.

For example, the porous carrier medium may comprise an igneous rock having a porosity of between 30 percent and 85 percent.

For example, the porous carrier medium may comprise a sedimentary rock having a porosity of between 2 percent and 40 percent.

The porous carrier medium may be mesoporous. That is, the porous carrier medium may comprise pores having a pore size of between 2 nanometres and 50 nanometres.

The porous carrier medium may be macroporous. That is, the porous carrier medium may comprise pores having a pore size of greater than 50 nanometres.

The porous carrier medium may comprise mesopores and macropores.

The porous carrier medium may have a minimum pore size of greater than or equal to 50 nanometres, greater than or equal to 1 micrometre, greater than or equal to 2 micrometres, or greater than equal to 5 micrometres.

The porous carrier medium may have a maximum pore size of less than or equal to 200 micrometres, less than or equal to 100 micrometres, less than or equal to 50 micrometres or less than or equal to 20 micrometres.

The minimum and maximum pore sizes of the porous carrier medium may be greater where the second aerosol-generating substrate is a gel.

For example, the porous carrier medium may be a ceramic having a pore size of between 1 micrometre and 100 micrometres or between 2 micrometres and 50 micrometres.

The porosity and the pore size distribution of the porous carrier medium may advantageously be selected to optimise releasable retention of an aerosol-generating substrate within the pores of the porous carrier medium. For example, the porosity and the pore size distribution of the porous carrier medium may be selected to optimise releasable retention of an aerosol-generating substrate within the pores of the porous carrier medium based on the viscosity of the aerosol-generating substrate.

The porosity and the pore size distribution of the porous carrier medium may be naturally occurring properties of the porous carrier medium. For example, where the porous carrier medium comprises an igneous rock or a sedimentary rock, the porosity and the pore size distribution of the porous carrier medium may be naturally occurring properties of the igneous rock or the sedimentary rock.

The porosity and the pore size distribution of the porous carrier medium may be manufactured properties of the porous carrier medium. For example, where the porous carrier medium comprises a ceramic, the porosity and the pore size distribution of the porous carrier medium may be controlled by the manufacturing process.

The porosity and pore size distribution of the porous carrier medium may be measured one or more of CO₂ gas adsorption, N2 gas adsorption, and mercury porosimetry.

The plurality of aerosol-generating granules may have a median particle size of greater than or equal to 0.1 millimetres, greater than or equal to 0.3 millimetres, or greater than or equal to 0.5 millimetres.

As used herein, the term “median particle size” refers to the “D50 size”. The D50 size is the particle size which splits the distribution in half, where half of the particles are larger than the D50 size and half of the particles are smaller than the D50 size. The particle size distribution may be determined by laser diffraction. For example, the particle size distribution may be determined by laser diffraction using a Malvern Mastersizer 3000 laser diffraction particle size analyser in accordance with the manufacturer's instructions.

The plurality of aerosol-generating granules may have a median particle size of less than or equal to 3 millimetres, less than or equal to 1.5 millimetres, or less than or equal to 1 millimetre. The plurality of aerosol-generating granules may have a median particle size of between 0.1 millimetres and 3 millimetres, between 0.1 millimetres and 1.5 millimetres, or between 0.1 millimetres and 1 millimetre.

The plurality of aerosol-generating granules may have a median particle size of between 0.3 millimetres and 3 millimetres, between 0.3 millimetres and 1.5 millimetres, or between 0.3 millimetres and 1 millimetre.

The plurality of aerosol-generating granules may have a median particle size of between 0.5 millimetres and 3 millimetres, between 0.5 millimetres and 1.5 millimetres, or between 0.5 millimetres and 1 millimetre.

The median particle size of the aerosol-generating granules may be selected to provide a desired surface area to volume ratio.

The median size of the aerosol-generating granules relative to the pore size distribution of the porous carrier medium may be selected to optimise releasable retention of an aerosol-generating substrate within the pores of the porous carrier medium.

The plurality of aerosol-generating granules may have a specific surface area of greater than or equal to 0.5 square metres per gram, greater than or equal to 1 metre square metres per gram, greater than or equal to 2 square metres per gram, greater than or equal to 5 square metres per gram, or greater than or equal to 10 square metres per gram. As used herein, the term “specific surface area” refers to the surface area as determined by the BET (Brunauer-Emmett-Teller) method in accordance with ISO 9277:2022.

The plurality of aerosol-generating granules may have a specific surface area of less than or equal to 1000 square metres per gram, less than or equal to 800 square metres per gram, less than or equal to 500 square metres per gram, less than or equal to 200 square metres per gram, or less than or equal to 100 square metres per gram.

The plurality of aerosol-generating granules may have a specific surface area of between 0.5 metres square metres per gram and 1000 metres square metres per gram, between 0.5 square metres per gram and 800 square metres per gram, between 0.5 square metres per gram and 500 square metres per gram, between 0.5 metres square metres per gram and 200 square metres per gram, or between 0.5 square metres per gram and 100 square metres per gram.

The plurality of aerosol-generating granules may have a specific surface area of between 1 square metre per gram and 1000 square metres per gram, between 1 square metre per gram and 800 square metres per gram, between 1 square metre per gram and 500 square metres per gram, between 1 square metre per gram and 200 square metres per gram, or between 1 square metre per gram and 100 square metres per gram.

The plurality of aerosol-generating granules may have a specific surface area of between 2 square metres per gram and 1000 square metres per gram, between 2 square metres per gram and 800 square metres per gram, between 2 square metres per gram and 500 square metres per gram, between 2 square metres per gram and 200 square metres per gram, or between 2 square metres per gram and 100 square metres per gram.

The plurality of aerosol-generating granules may have a specific surface area of between 5 square metres per gram and 1000 square metres per gram, between 5 square metres per gram and 800 square metres per gram, between 5 square metres per gram and 500 square metres per gram, between 5 square metres per gram and 200 square metres per gram, or between 5 square metres per gram and 100 square metres per gram.

The plurality of aerosol-generating granules may have a specific surface area of between 10 square metres per gram and 1000 square metres per gram, between 10 square metres per gram and 800 square metres per gram, between 10 square metres per gram and 500 square metres per gram, between 10 square metres per gram and 200 square metres per gram, or between 10 square metres per gram and 100 square metres per gram.

The plurality of aerosol-generating granules may have any suitable shape.

Advantageously, the plurality of aerosol-generating granules are substantially spherical. Substantially spherical aerosol-generating granules have a maximum surface area for a given volume. This may be particularly advantageous where the porous carrier medium has a closed-cell structure.

The plurality of aerosol-generating granules may comprise at least 5 aerosol-generating granules, at least 10 aerosol-generating granules, at least 25 aerosol-generating granule, or at least aerosol-generating granules 50 granules.

The plurality of aerosol-generating granules may comprise less than or equal to 200 aerosol-generating granules, less than or equal to 150 aerosol-generating granules, or less than or equal to 100 granules.

The plurality of aerosol-generating granules may comprise between 5 and 200 aerosol-generating granules, between 5 and 150 aerosol-generating granules, or between 5 and 100 aerosol-generating granules.

The plurality of aerosol-generating granules may comprise between 10 and 200 aerosol-generating granules, between 10 and 150 aerosol-generating granules, or between 10 and 100 aerosol-generating granules.

The plurality of aerosol-generating granules may comprise between 25 and 200 aerosol-generating granules, between 25 and 150 aerosol-generating granules, or between 25 and 100 aerosol-generating granules.

The plurality of aerosol-generating granules may comprise between 50 and 200 aerosol-generating granules, between 50 and 150 aerosol-generating granules, or between 50 and 100 aerosol-generating granules.

Some or all of the plurality of aerosol-generating granules may be in contact with the first aerosol-generating substrate.

Some or all of the plurality of aerosol-generating granules may be dispersed in the first aerosol-generating substrate.

Where the first aerosol-generating substrate is a liquid, some or all of the plurality of aerosol-generating granules may be immersed in the first aerosol-generating substrate.

Where the first aerosol-generating substrate is a gel, some or all of the plurality of aerosol-generating granules may be embedded in the first aerosol-generating substrate.

The average density of the plurality of aerosol-generating granules may be substantially the same as the density of the first aerosol-generating substrate. Where the first aerosol-generating substrate is a liquid, this may advantageously facilitate immersion of the plurality of aerosol-generating granules in the first aerosol-generating substrate.

The plurality of aerosol-generating granules may be substantially evenly dispersed in the first aerosol-generating substrate.

For example, a percentage difference between the average envelope density of the plurality of aerosol-generating granules and the density of the first aerosol-generating substrate may be less than or equal to 10 percent or less than or equal to 5 percent.

The ratio of the total envelope volume of the plurality of the aerosol-generating granules to the total envelope volume of the first aerosol-generating substrate may be greater than or equal to 0.25. For example, the ratio of the total envelope volume of the plurality of the aerosol-generating granules to the total volume of the first aerosol-generating substrate may be greater than or equal to 0.5 or greater than or equal to 1.

The ratio of the total envelope volume of the plurality of the aerosol-generating granules to the total volume of the first aerosol-generating substrate may be less than or equal to 5. For example, the ratio of the total envelope volume of the plurality of the aerosol-generating granules to the total volume of the first aerosol-generating substrate may be less than or equal to 4 or less than or equal to 3.

The ratio of the total envelope volume of the plurality of the aerosol-generating granules to the total volume of the first aerosol-generating substrate may be between 0.25 and 5, between 0.25 and 4, or between 0.25 and 3.

The ratio of the total envelope volume of the plurality of the aerosol-generating granules to the total volume of the first aerosol-generating substrate may be between 0.5 and 5, between 0.5 and 4, or between 0.5 and 3.

The ratio of the total envelope volume of the plurality of the aerosol-generating granules to the total volume of the first aerosol-generating substrate may be between 1 and 5, between 1 and 4, or between 1 and 3.

The ratio of the total volume of second aerosol-generating substrate to the total volume of the first aerosol-generating substrate may be greater than or equal to 0.1. For example, the ratio of the total volume of the second aerosol-generating substrate to the total volume of the first aerosol-generating substrate may be greater than or equal to 0.25 or less than or equal to 0.5.

The ratio of the total volume of the second aerosol-generating substrate to the total volume of the first aerosol-generating substrate may be less than or equal to 4. For example, the ratio of the total volume of the second aerosol-generating substrate to the total volume of the first aerosol-generating substrate may be less than or equal to 3 or less than or equal to 2.

The ratio of the total volume of the second aerosol-generating substrate to the total volume of the first aerosol-generating substrate may be between 0.1 and 4, between 0.1 and 3, or between 0.1 and 2.

The ratio of the total volume of the second aerosol-generating substrate to the total volume of the first aerosol-generating substrate may be between 0.25 and 4, between 0.25 and 2, or between 0.25 and 2.

The ratio of the total volume of the second aerosol-generating substrate to the total volume of the first aerosol-generating substrate may be between 0.5 and 4, between 0.5 and 3, or between 0.5 and 2.

The second aerosol-generating substrate may be a liquid aerosol-generating substrate.

The second aerosol-generating substrate may be a gel aerosol-generating substrate.

The second aerosol-generating substrate comprises a flavourant and an aerosol former.

The second aerosol-generating substrate may comprise one or more flavourants.

The second aerosol-generating substrate may comprise one or more natural flavourants.

The second aerosol-generating substrate may comprise one or more synthetic flavourants.

The second aerosol-generating substrate may comprise any suitable flavourant. Suitable flavourants include, but are not limited to: menthol; peppermint oil; gamma octalactone; vanillin; ethyl vanillin; methyl salicylate; linalool; bergamot oil; geranium oil; ginger oil; and lemon oil.

The aerosol former may be any suitable known compound or mixture of compounds that, in use, facilitates formation of a dense and stable aerosol. The aerosol former may be substantially resistant to thermal degradation at temperatures typically reached during use of an aerosol-generating system according to the second aspect of the invention.

Examples of suitable aerosol formers include: polyhydric alcohols such as, for example, triethylene glycol, 1,3-butanediol, propylene glycol and glycerine; esters of polyhydric alcohols such as, for example, glycerol mono-, di- or triacetate; aliphatic esters of mono-, di- or polycarboxylic acids such as, for example, dimethyl dodecanedioate and dimethyl tetradecanedioate; and combinations thereof.

Advantageously, the aerosol former may comprise one or more polyhydric alcohols.

More advantageously, the aerosol former comprises one or more polyhydric alcohols selected from the group consisting of propylene glycol, triethylene glycol, 1,3-butanediol and glycerine.

The aerosol former may comprise one or both of glycerine and propylene glycol. The aerosol former may consist of glycerine. The aerosol former may consist of propylene glycol. The aerosol former may consist of a combination of glycerine and propylene glycol.

The second aerosol-generating substrate may comprise water.

The second aerosol-generating substrate may comprise a gelling agent.

The second aerosol-generating substrate may comprise nicotine.

The second aerosol-generating substrate may be a liquid nicotine formulation.

The second aerosol-generating substrate may be a gel nicotine formulation.

The second aerosol-generating substrate may comprise natural nicotine.

The second aerosol-generating substrate may comprise synthetic nicotine.

The second aerosol-generating substrate may have a nicotine content of greater than or equal to 0.5 percent by weight, greater than or equal to 1 percent by weight, or greater than or equal to 1.5 percent by weight.

The second aerosol-generating substrate may have a nicotine content of less than or equal to 10 percent by weight, less than or equal to 5 percent by weight, or less than or equal to 3 percent by weight.

The second aerosol-generating substrate may have a nicotine content of between 0.5 percent by weight and 10 percent by weight. For example, the second aerosol-generating substrate may have a nicotine content of between 0.5 percent by weight and 5 percent by weight or between 0.5 percent by weight and 3 percent by weight.

The second aerosol-generating substrate may have a nicotine content of between 1 percent by weight and 10 percent by weight. For example, the second aerosol-generating substrate may have a nicotine content of between 1 percent by weight and 5 percent by weight or between 1 percent by weight and 3 percent by weight.

The second aerosol-generating substrate may have a nicotine content of between 1.5 percent by weight and 10 percent by weight. For example, the second aerosol-generating substrate may have a nicotine content of between 1.5 percent by weight and 5 percent by weight or between 1.5 percent by weight and 3 percent by weight.

For example, the second aerosol-generating substrate may have a nicotine content of 2 percent by weight.

The composition of the second aerosol-generating substrate may advantageously be selected to provide one or more physical properties that optimise releasable retention of the aerosol-generating substrate within the pores of the porous carrier medium. For example, the composition of the second aerosol-generating substrate may be selected to provide a viscosity that optimises releasable retention of the second aerosol-generating substrate within the pores of the porous carrier medium.

The composition of the second aerosol-generating substrate may be substantially the same as the composition of the first aerosol-generating substrate.

The composition of the second aerosol-generating substrate may be different to the composition of the first aerosol-generating substrate. As described above, where the composition of the second aerosol-generating substrate is different to the composition of the first aerosol-generating substrate, releasable retention of the second aerosol-generating substrate within the pores of the porous carrier medium may advantageously prevent or reduce chemical interactions between components of the first aerosol-generating substrate and components of the second aerosol-generating substrate.

The composition of the second aerosol-generating substrate may be selected to provide a desired aerosolization temperature. For example, the aerosol former in the second aerosol-generating substrate may be selected to provide a desired aerosolization temperature.

The aerosolization temperature of the second aerosol-generating substrate may be substantially the same as the aerosolization temperature of the first aerosol-generating substrate.

Advantageously, the aerosolization temperature of the second aerosol-generating substrate may be different to the aerosolization temperature of the first aerosol-generating substrate. As previously described above, where the aerosolization temperature of the second aerosol-generating substrate is different to the aerosolization temperature of the first aerosol-generating substrate, the second aerosol-generating substrate may generate aerosol earlier or later in the user experience than the first aerosol-generating substrate. This may advantageously allow for more consistent aerosol generation and delivery to a user.

The plurality of aerosol-generating granules comprising the second aerosol-generating substrate may be a plurality of first aerosol-generating granules comprising a first porous carrier medium and the cartridge may further comprise a plurality of second aerosol-generating granules comprising a second porous carrier medium defining a plurality of pores and a third aerosol-generating substrate releasably retained within the pores of the second porous carrier medium, wherein the third aerosol-generating substrate is a liquid or a gel, wherein the second aerosol-generating granules are different from the first aerosol-generating granules. That is, the cartridge may comprise: a compartment containing a first aerosol-generating substrate, wherein the first aerosol-generating substrate is a liquid or a gel; a plurality of first aerosol-generating granules comprising a first porous carrier medium defining a plurality of pores and a second aerosol-generating substrate releasably retained within the pores of the first porous carrier medium, wherein the second aerosol-generating substrate is a liquid or a gel comprising a flavourant and an aerosol former; and a plurality of second aerosol-generating granules comprising a second porous carrier medium defining a plurality of pores and a third aerosol-generating substrate releasably retained within the pores of the second porous carrier medium, wherein the third aerosol-generating substrate is a liquid or a gel, wherein the second aerosol-generating granules are different from the first aerosol-generating granules.

The plurality of second aerosol-generating granules may comprise any porous carrier medium described above as suitable for inclusion in the plurality of first aerosol-generating granules.

The second porous carrier medium may have any of the properties described above for the first porous carrier medium.

The third aerosol-generating substrate may be a liquid aerosol-generating substrate.

The third aerosol-generating substrate may be a gel aerosol-generating substrate.

The third aerosol-generating substrate may comprise an aerosol former.

The third aerosol-generating substrate may comprise any aerosol former described above as suitable for inclusion in the first aerosol-generating substrate or second aerosol-generating substrate.

The third aerosol-generating substrate may comprise a flavourant.

The third aerosol-generating substrate may comprise any flavourant described above as suitable for inclusion in the second aerosol-generating substrate.

The third aerosol-generating substrate may comprise a flavourant and an aerosol former.

That is, the cartridge may comprise: a compartment containing a first aerosol-generating substrate, wherein the first aerosol-generating substrate is a liquid or a gel; a plurality of first aerosol-generating granules comprising a first porous carrier medium defining a plurality of pores and a second aerosol-generating substrate releasably retained within the pores of the first porous carrier medium, wherein the second aerosol-generating substrate is a liquid or a gel comprising a first flavourant and a first aerosol former; and a plurality of second aerosol-generating granules comprising a second porous carrier medium defining a plurality of pores and a third aerosol-generating substrate releasably retained within the pores of the second porous carrier medium, wherein the third aerosol-generating substrate is a liquid or a gel comprising a second flavourant and a second aerosol former, wherein the second aerosol-generating granules are different from the first aerosol-generating granules.

The third aerosol-generating substrate may comprise water.

The third aerosol-generating substrate may comprise a gelling agent.

The third aerosol-generating substrate may comprise nicotine.

The third aerosol-generating substrate may be a liquid nicotine formulation.

The third aerosol-generating substrate may be a gel nicotine formulation.

The third aerosol-generating substrate may comprise natural nicotine.

The third aerosol-generating substrate may comprise synthetic nicotine.

The third aerosol-generating substrate may have a nicotine content of greater than or equal to 0.5 percent by weight, greater than or equal to 1 percent by weight, or greater than or equal to 1.5 percent by weight.

The third aerosol-generating substrate may have a nicotine content of less than or equal to 10 percent by weight, less than or equal to 5 percent by weight, or less than or equal to 3 percent by weight.

The third aerosol-generating substrate may have a nicotine content of between 0.5 percent by weight and 10 percent by weight. For example, the third aerosol-generating substrate may have a nicotine content of between 0.5 percent by weight and 5 percent by weight or between 0.5 percent by weight and 3 percent by weight.

The third aerosol-generating substrate may have a nicotine content of between 1 percent by weight and 10 percent by weight. For example, the third aerosol-generating substrate may have a nicotine content of between 1 percent by weight and 5 percent by weight or between 1 percent by weight and 3 percent by weight.

The third aerosol-generating substrate may have a nicotine content of between 1.5 percent by weight and 10 percent by weight. For example, the third aerosol-generating substrate may have a nicotine content of between 1.5 percent by weight and 5 percent by weight or between 1.5 percent by weight and 3 percent by weight.

For example, the third aerosol-generating substrate may have a nicotine content of 2 percent by weight.

The composition of the third aerosol-generating substrate may advantageously be selected to provide one or more physical properties that optimise releasable retention of the aerosol-generating substrate within the pores of the second porous carrier medium. For example, the composition of the third aerosol-generating substrate may be selected to provide a viscosity that optimises releasable retention of the third aerosol-generating substrate within the pores of the second porous carrier medium.

The second porous carrier medium of the second aerosol-generating granules may be substantially the same as the first porous carrier medium of the first aerosol-generating granules.

The second porous carrier medium of the second aerosol-generating granules may be different to the first porous carrier medium of the first aerosol-generating granules.

The composition of the second porous carrier medium may be different to the composition of the first porous carrier medium. For example, the second porous carrier medium may comprise an igneous rock, such as basalt, and the first porous carrier medium may comprise a sedimentary rock, such as limestone.

One or more physical properties of the second porous carrier medium may be different to one or more physical properties of the first porous carrier medium. For example, the second porous carrier medium may have one or both of a different porosity and a different median particle size to the first porous carrier medium.

The composition of the third aerosol-generating substrate may be substantially the same as the composition of the second aerosol-generating substrate.

Advantageously, the third aerosol-generating substrate may have a different composition to the second aerosol-generating substrate.

The second aerosol-generating substrate may comprise a first flavourant and the third aerosol-generating substrate may comprise a second flavourant and the second flavourant may be different to the first flavourant. For example, the second flavourant may be menthol and the first flavourant may be vanillin.

The second aerosol-generating substrate may comprise a first aerosol former and the third aerosol-generating substrate may comprise a second aerosol former and the second aerosol former may be different to the first aerosol former. For example, the second aerosol former may be glycerine and the first aerosol former may be propylene glycol.

The second porous carrier medium of the second aerosol-generating granules may be substantially the same as the first porous carrier medium of the first aerosol-generating granules and the third aerosol-generating substrate may have a different composition to the second aerosol-generating substrate.

The second porous carrier medium of the second aerosol-generating granules may be different to the first porous carrier medium of the first aerosol-generating granules and the composition of the third aerosol-generating substrate may be substantially the same as the composition of the second aerosol-generating substrate.

The second porous carrier medium of the second aerosol-generating granules may be different to the first porous carrier medium of the first aerosol-generating granules and the third aerosol-generating substrate may have a different composition to the second aerosol-generating substrate.

The composition of the third aerosol-generating substrate may be substantially the same as the composition of the first aerosol-generating substrate.

The composition of the third aerosol-generating substrate may be different to the composition of the first aerosol-generating substrate. Where the composition of the third aerosol-generating substrate is different to the composition of the first aerosol-generating substrate, releasable retention of the third aerosol-generating substrate within the pores of the porous carrier medium may advantageously prevent or reduce chemical interactions between components of the first aerosol-generating substrate and components of the third aerosol-generating substrate.

Advantageously, the composition of each of the first aerosol-generating substrate, the second aerosol-generating substrate, and the third aerosol-generating substrate may be different.

The aerosolization temperature of the third aerosol-generating substrate may be substantially the same as the aerosolization temperature of the first aerosol-generating substrate.

Advantageously, the aerosolization temperature of the third aerosol-generating substrate may be different to the aerosolization temperature of the first aerosol-generating substrate. Where the aerosolization temperature of the third aerosol-generating substrate is different to the aerosolization temperature of the first aerosol-generating substrate, the third aerosol-generating substrate may generate aerosol earlier or later in the user experience than the first aerosol-generating substrate. This may advantageously allow for more consistent aerosol generation and delivery to a user.

The aerosolization temperature of the third aerosol-generating substrate may be substantially the same as the aerosolization temperature of the second aerosol-generating substrate.

Advantageously, the aerosolization temperature of the third aerosol-generating substrate may be different to the aerosolization temperature of the second aerosol-generating substrate. Where the aerosolization temperature of the third aerosol-generating substrate is different to the aerosolization temperature of the second aerosol-generating substrate, the third aerosol-generating substrate may generate aerosol earlier or later in the user experience than the second aerosol-generating substrate. This may advantageously allow for more consistent aerosol generation and delivery to a user.

Advantageously, the aerosolization temperature of each of the first aerosol-generating substrate, the second aerosol-generating substrate, and the third aerosol-generating substrate may be different. For example, the aerosolization temperature of the second aerosol-generating substrate may be lower than the aerosolization temperature of the first aerosol-generating substrate and the aerosolization temperature of the third aerosol-generating substrate may be higher than the aerosolization temperature of the first aerosol-generating substrate. Where the aerosolization temperature of the second aerosol-generating substrate is lower than the aerosolization temperature of the first aerosol-generating substrate and the aerosolization temperature of the third aerosol-generating substrate is higher than the aerosolization temperature of the first aerosol-generating substrate, the second aerosol-generating substrate may generate aerosol earlier in the user experience than the first aerosol-generating substrate and the third aerosol-generating substrate may generate aerosol later in the user experience than the first aerosol-generating substrate. This may advantageously allow for more consistent aerosol generation and delivery to a user.

The cartridge comprises a compartment containing the first aerosol-generating substrate. The compartment may be referred to as a storage compartment or reservoir.

The compartment may contain the plurality of aerosol-generating granules. That is, the compartment may contain the first aerosol-generating substrate and the plurality of aerosol-generating granules.

The compartment may have any suitable shape.

The compartment may be substantially cylindrical. The compartment may have a substantially circular cross-section.

Some or all of the plurality of aerosol-generating granules may be in contact within the first aerosol-generating substrate.

Some or all of the plurality of aerosol-generating granules may be dispersed within the first aerosol-generating substrate.

Where the first aerosol-generating substrate is a liquid, some or all of the plurality of aerosol-generating granules may be immersed in the first aerosol-generating substrate.

Where the first aerosol-generating substrate is a gel, some or all of the plurality of aerosol-generating granules may be embedded in the first aerosol-generating substrate.

The plurality of aerosol-generating granules may be substantially evenly dispersed in the first aerosol-generating substrate.

Where the cartridge comprises a plurality of first aerosol-generating granules and a plurality of second aerosol-generating granules, the compartment may contain one or both of the plurality of first aerosol-generating granules and the plurality of second aerosol-generating granules. That is, the compartment may contain the first aerosol-generating substrate and the plurality of first aerosol-generating granules, or the compartment may contain the first aerosol-generating substrate and the plurality of second aerosol-generating granules, or the compartment may contain the first aerosol-generating substrate, the plurality of first aerosol-generating granules, and the plurality of second aerosol-generating granules.

Some or all of the plurality of first aerosol-generating granules may be in contact within the first aerosol-generating substrate.

Some or all of the plurality of first aerosol-generating granules may be dispersed within the first aerosol-generating substrate.

Where the first aerosol-generating substrate is a liquid, some or all of the plurality of first aerosol-generating granules may be immersed in the first aerosol-generating substrate.

Where the first aerosol-generating substrate is a gel, some or all of the plurality of first aerosol-generating granules may be embedded in the first aerosol-generating substrate.

The plurality of first aerosol-generating granules may be substantially evenly dispersed in the first aerosol-generating substrate.

Some or all of the plurality of second aerosol-generating granules may be in contact within the first aerosol-generating substrate.

Some or all of the plurality of second aerosol-generating granules may be dispersed within the first aerosol-generating substrate.

Where the first aerosol-generating substrate is a liquid, some or all of the plurality of second aerosol-generating granules may be immersed in the first aerosol-generating substrate.

Where the first aerosol-generating substrate is a gel, some or all of the plurality of second aerosol-generating granules may be embedded in the first aerosol-generating substrate.

The plurality of second aerosol-generating granules may be substantially evenly dispersed in the first aerosol-generating substrate.

The cartridge may comprise a plurality of compartments.

The cartridge may comprise a first compartment and a second compartment.

The compartment containing the first aerosol-generating substrate may be a first compartment and the cartridge may further comprise a second compartment containing the plurality of aerosol-generating granules. That is, the cartridge may comprise: a first compartment containing a first aerosol-generating substrate, wherein the first aerosol-generating substrate is a liquid or a gel; and a second compartment containing a plurality of aerosol-generating granules, wherein the plurality of aerosol-generating granules comprise a porous carrier medium defining a plurality of pores and a second aerosol-generating substrate releasably retained within the pores of the porous carrier medium, wherein the second aerosol-generating substrate is a liquid or a gel comprising a flavourant and an aerosol former.

The first compartment and second compartment may be arranged in series within the cartridge. In other words, the first compartment may be upstream of the second compartment or the first compartment may be downstream of the second compartment.

The first compartment and second compartment may be arranged in parallel within the cartridge. The first compartment and second compartment may be arranged side by side. The second compartment may circumscribe the first compartment or the first compartment may circumscribe the second compartment.

Where the cartridge comprises a plurality of first aerosol-generating granules and a plurality of second aerosol-generating granules, the first compartment may contain the first aerosol-generating substrate and the plurality of first aerosol-generating granules and the second compartment may contain the plurality of second aerosol-generating granules.

Where the cartridge comprises a plurality of first aerosol-generating granules and a plurality of second aerosol-generating granules, the first compartment may contain the first aerosol-generating substrate and the plurality of second aerosol-generating granules and the second compartment may contain the plurality of first aerosol-generating granules.

Where the cartridge comprises a plurality of first aerosol-generating granules and a plurality of second aerosol-generating granules, the first compartment may contain the first aerosol-generating substrate and the second compartment may contain the plurality of first aerosol-generating granules and the plurality of second aerosol-generating granules. The plurality of first aerosol-generating granules and the plurality of second aerosol-generating granules may be randomly interspersed within the second compartment.

The cartridge may have any suitable shape. For example, the cartridge may be substantially cylindrical.

The cartridge may have any suitable cross-sectional shape. For example, the cross-sectional shape of the cartridge may be circular, semi-circular, elliptical, triangular, square, rectangular or trapezoidal.

The cartridge may have any suitable size.

The cartridge may be formed from any suitable material or combination of materials. Suitable materials include, but are not limited to, aluminium, polyether ether ketone (PEEK), polyimides, such as Kapton®, polyethylene terephthalate (PET), polyethylene (PE), high-density polyethylene (HDPE), polypropylene (PP), polystyrene (PS), fluorinated ethylene propylene (FEP), polytetrafluoroethylene (PTFE), polyoxymethylene (POM), epoxy resins, polyurethane resins, vinyl resins, liquid crystal polymers (LCP) and modified LCPs, such as LCPs with graphite or glass fibres.

The cartridge may be formed by any suitable method. Suitable methods include, but are not limited to, blistering, blow forming, deep drawing, extrusion, and injection moulding.

The cartridge may comprise a cavity for receiving a heating element configured to heat the first aerosol-generating substrate and the second aerosol-generating substrate.

Where the cartridge comprises a third aerosol-generating substrate, the cartridge may comprise a cavity for receiving a heating element configured to heat the first aerosol-generating substrate, the second aerosol-generating substrate, and the third aerosol-generating substrate.

Where the cartridge comprises a first compartment and a second compartment, the cavity may advantageously be located between the first compartment and the second compartment.

Advantageously, the cavity extends along the longitudinal axis of the cartridge.

Advantageously, the cavity extends from the distal end of the cartridge at least part way along the length of the cartridge.

The cartridge may comprise a mouthpiece.

The mouthpiece may comprise a cooling chamber.

The compartment may be separated from the cooling chamber by a valve element. The valve element may allow aerosol to flow from the compartment into the cooling chamber. The valve element may prevent liquid from flowing from the compartment into the cooling chamber.

Where the cartridge comprises a first compartment and a second compartment, the first compartment may be separated from the cooling chamber by a first valve element. The first valve element may allow aerosol to flow from the first compartment into the cooling chamber. The first valve element may prevent liquid from flowing from the first compartment into the cooling chamber.

Where the cartridge comprises a first compartment and a second compartment, the second compartment may be separated from the cooling chamber by a second valve element. The second valve element may allow aerosol to flow from the second compartment into the cooling chamber. The second valve element may prevent liquid from flowing from the second compartment into the cooling chamber.

The cartridge may comprise one or more air inlets through which, in use, air may be drawn into the cartridge. Where the cartridge comprises a mouthpiece comprising a cooling chamber, the cartridge may comprise one or more air inlets through which, in use, air may be drawn into the cooling chamber.

The cartridge may comprise one or more air outlets through which, in use, aerosol may be drawn out of the cartridge. Where the cartridge comprises a mouthpiece, the cartridge may comprise one or more air outlets through which, in use, aerosol may be drawn out of the mouthpiece.

The cartridge may be designed to be disposed of once the first aerosol-generating and the second aerosol-generating substrate are depleted.

The cartridge may be designed to be refillable.

Aerosol-generating systems according to the second aspect of the invention comprise: a cartridge according to the first aspect of the invention; and an aerosol-generating device.

The aerosol-generating device is configured to heat the first aerosol-generating substrate and the second aerosol-generating substrate of the cartridge. Where the cartridge comprises a third aerosol-generating substrate, the aerosol-generating device may be configured to heat the third aerosol-generating substrate.

Preferably, the aerosol-generating system is a handheld aerosol-generating system.

More preferably, the aerosol-generating system is a handheld electrically operated aerosol-generating system.

The aerosol-generating device may comprise a housing defining a device cavity configured to receive at least a portion of the cartridge.

The aerosol-generating device may comprise a housing defining a device cavity configured to receive the compartment of the cartridge.

Where the cartridge comprises a first compartment and a second compartment, aerosol-generating device may comprise a housing defining a device cavity configured to receive the first compartment and the second compartment of the cartridge.

The aerosol-generating device may comprise a heating element.

The aerosol-generating device may comprise a resistive heating element.

The aerosol-generating device may comprise an inductive heating element.

The aerosol-generating device may comprise a susceptor element.

As used herein, the term “susceptor element” is used to describe an element comprising a susceptor material that is capable of converting electromagnetic energy into heat. When located within an alternating or fluctuating electromagnetic field, at least one of hysteresis losses and eddy currents induced in the susceptor element cause heating of the susceptor element.

The aerosol-generating device may comprise an inductor coil.

The aerosol-generating device may comprise an external heating element. Where the aerosol-generating device comprises a housing defining a device cavity configured to receive at least a portion of the cartridge, the external heating element may be located about the periphery of the device cavity.

The aerosol-generating device may comprise an internal heating element configured for insertion into the cartridge. Where the aerosol-generating device comprises a housing defining a device cavity configured to receive at least a portion of the cartridge, the internal heating element may be located in the device cavity.

The aerosol-generating device may comprise a power supply. The power supply may be a DC power supply. The power supply may be a battery. The power supply may be a rechargeable battery.

The aerosol-generating device may comprise control circuitry. The control circuitry may be configured to control the supply of power from the power supply to the heating element.

The aerosol-generating device may comprise a battery and control circuitry.

The invention is defined in the claims. However, below there is provided a non-exhaustive list of non-limiting examples. Any one or more of the features of these examples may be combined with any one or more features of another example, embodiment, or aspect described herein.

Example Ex1: A cartridge for an aerosol-generating system, the cartridge comprising:

a compartment containing a first aerosol-generating substrate, wherein the first aerosol-generating substrate is a liquid or a gel; and

a plurality of aerosol-generating granules, wherein the plurality of aerosol-generating granules comprise a porous carrier medium defining a plurality of pores and a second aerosol-generating substrate releasably retained within the pores of the porous carrier medium, wherein the second aerosol-generating substrate is a liquid or a gel comprising a flavourant and an aerosol former.

Example Ex2: a cartridge according to example Ex1, wherein the compartment contains the plurality of aerosol-generating granules.

Example Ex3: A cartridge according to example Ex2, wherein some or all of the plurality of aerosol-generating granules are dispersed in the first aerosol-generating substrate.

Example Ex4: A cartridge according to any one of examples Ex1 to Ex3, wherein the first aerosol-generating substrate is a liquid and some or all of the plurality of aerosol-generating granules are immersed in the first aerosol-generating substrate.

Example Ex5: A cartridge according to any one of examples Ex1 to Ex3, wherein the first aerosol-generating substrate is a gel and some or all of the plurality of aerosol-generating granules are embedded in the first aerosol-generating substrate.

Example Ex6: A cartridge according to example Ex1, wherein the compartment containing the first aerosol-generating substrate is a first compartment and the cartridge further comprises a second compartment containing the plurality of aerosol-generating granules.

Example Ex7: A cartridge according to any one of examples Ex1 to Ex6, wherein the second aerosol-generating substrate has a different composition to the first aerosol-generating substrate.

Example Ex8: A cartridge according to any one of examples Ex1 to Ex7, wherein the first aerosol-generating substrate comprises nicotine and an aerosol former.

Example Ex9: A cartridge according to any one of examples Ex1 to Ex8, wherein the porous carrier medium has an open-cell structure.

Example Ex10: A cartridge according to any one of examples Ex1 to Ex8, wherein the porous carrier medium has a closed-cell structure.

Example Ex11: A cartridge according to any one of examples Ex1 to Ex10, wherein the porous carrier medium comprises one or more of a ceramic, an igneous rock, and a sedimentary rock.

Example Ex12: A cartridge according to any one of examples Ex1 to Ex11, wherein the porous carrier medium comprises one or more of an igneous rock and a sedimentary rock.

Example Ex13: A cartridge according to any one of examples Ex1 to Ex12, wherein the porous carrier medium comprises one or more of basalt, pumice, scoria, expanded clay, limestone, and sandstone.

Example Ex14: A cartridge according to any one of examples Ex1 to Ex13, wherein the porous carrier medium has a porosity of greater than or equal to 2 percent.

Example Ex15: A cartridge according to any one of examples Ex1 to Ex14, wherein the porous carrier medium has a porosity of greater than or equal to 5 percent.

Example Ex16: A cartridge according to any one of examples Ex1 to Ex15, wherein the porous carrier medium has a porosity of greater than or equal to 10 percent.

Example Ex17: A cartridge according to any one of examples Ex1 to Ex16, wherein the porous carrier medium has a porosity of greater than or equal to 20 percent.

Example Ex18: A cartridge according to any one of examples Ex1 to Ex17, wherein the porous carrier medium has a porosity of greater than or equal to 30 percent.

Example Ex19: A cartridge according to any one of examples Ex1 to Ex18, wherein the porous carrier medium has a porosity of less than or equal to 85 percent.

Example Ex20: A cartridge according to any one of examples Ex1 to Ex19, wherein the porous carrier medium has a porosity of less than or equal to 70 percent.

Example Ex21: A cartridge according to any one of examples Ex1 to Ex20, wherein the porous carrier medium has a porosity of less than or equal to 50 percent.

Example Ex22: A cartridge according to any one of examples Ex1 to Ex21, wherein the porous carrier medium has a porosity of less than or equal to 40 percent.

Example Ex23: A cartridge according to any one of examples Ex1 to Ex22, wherein the plurality of aerosol-generating granules have a median particle size of greater than or equal to 0.1 millimetres.

Example Ex24: A cartridge according to any one of examples Ex1 to Ex23, wherein the plurality of aerosol-generating granules have a median particle size of greater than or equal to 0.3 millimetres.

Example Ex25: A cartridge according to any one of examples Ex1 to Ex24, wherein the plurality of aerosol-generating granules have a median particle size of greater than or equal to 0.5 millimetres.

Example Ex26: A cartridge according to any one of examples Ex1 to Ex25, wherein the plurality of aerosol-generating granules have a median particle size of less than or equal to 3 millimetres,

Example Ex27: A cartridge according to any one of examples Ex1 to Ex26, wherein the plurality of aerosol-generating granules have a median particle size of less than or equal to 1.5 millimetres.

Example Ex28: A cartridge according to any one of examples Ex1 to Ex27, wherein the plurality of aerosol-generating granules have a median particle size of less than or equal to 1 millimetre.

Example Ex29: A cartridge according to any one of examples Ex1 to Ex28, wherein the plurality of aerosol-generating granules have a minimum pore size of greater than or equal to 1 micrometre.

Example Ex30: A cartridge according to any one of examples Ex1 to Ex29, wherein the plurality of aerosol-generating granules have a minimum pore size of greater than or equal to 5 micrometres.

Example Ex31: A cartridge according to any one of examples Ex1 to Ex30, wherein the plurality of aerosol-generating granules have a maximum pore size of less than or equal to 100 micrometres.

Example Ex32: A cartridge according to any one of examples Ex1 to Ex31, wherein the plurality of aerosol-generating granules have a maximum pore size of less than or equal to 20 micrometres.

Example Ex33: A cartridge according to any one of examples Ex1 to Ex32, wherein the plurality of aerosol-generating granules are substantially spherical.

Example Ex34: A cartridge according to any one of examples Ex1 to Ex33, wherein the plurality of granules comprises at least 10 aerosol-generating granules.

Example Ex35: A cartridge according to any one of examples Ex1 to Ex34, wherein the plurality of granules comprises less than or equal to 150 aerosol-generating granules.

Example Ex36: A cartridge according to any one of examples Ex1 to Ex35, wherein a percentage difference between the average density of the plurality of aerosol-generating granules and the density of the first aerosol-generating substrate is less than or equal to 10 percent.

Example Ex37: A cartridge according to any one of examples Ex1 to Ex36, wherein the second aerosol-generating substrate has a lower aerosolization temperature than the first aerosol-generating substrate.

Example Ex38: A cartridge according to any one of examples Ex1 to Ex36, wherein the second aerosol-generating substrate has a higher aerosolization temperature than the second aerosol-generating substrate.

Example Ex39: A cartridge according to any one of examples Ex1 to Ex38, wherein the plurality of aerosol-generating granules is a first plurality of aerosol-generating granules comprising a first porous carrier medium and the cartridge further comprises a second plurality of aerosol-generating granules comprising a second porous carrier medium defining a plurality of pores and a third aerosol-generating substrate releasably retained within the pores of the second porous carrier medium, wherein the third aerosol-generating substrate is a liquid or a gel, wherein the second aerosol-generating granules are different from the first aerosol-generating granules. Example Ex40: A cartridge according to example Ex39, wherein the second aerosol-generating substrate comprises a first flavourant and a first aerosol former and the third aerosol-generating substrate comprises a second flavourant and a second aerosol former.

Example Ex41: A cartridge according to example Ex39 or Ex40, wherein the third aerosol-generating substrate has a different composition to the second aerosol-generating substrate.

Example Ex42: A cartridge according to any one of examples Ex39 to Ex41, wherein the third aerosol-generating substrate has a lower aerosolization temperature than the second aerosol-generating substrate.

Example Ex43: A cartridge according to any one of examples Ex39 to Ex41, wherein the third aerosol-generating substrate has a higher aerosolization temperature than the second aerosol-generating substrate.

Example Ex44: A cartridge according to any one of examples Ex1 to Ex43, further comprising a mouthpiece.

Example Ex45: A cartridge according to example Ex44, wherein the mouthpiece comprises a cooling chamber.

Example Ex46: An aerosol-generating system comprising: a cartridge according to any one of examples Ex1 to Ex45; and an aerosol-generating device configured to heat the first aerosol-generating substrate and the second aerosol-generating substrate.

Example Ex47: An aerosol-generating system according to example Ex46, wherein the aerosol-generating device comprises a heating element.

Example Ex48: An aerosol-generating system according to example Ex47, wherein the aerosol-generating device comprises a resistive heating element.

Example Ex49: An aerosol-generating system according to any one of examples Ex46 to Ex48, wherein the aerosol-generating device comprises an inductive heating element.

Example Ex50: An aerosol-generating system according to any one of examples Ex46 to Ex49, wherein the aerosol-generating device comprises a susceptor element.

Example Ex51: An aerosol-generating system according to example Ex50, wherein the aerosol-generating device comprises an inductor coil.

Example Ex52: An aerosol-generating system according to any one of examples Ex46 to Ex51, wherein the aerosol-generating device comprises a housing defining a device cavity configured to receive at least a portion of the cartridge.

Example Ex53: An aerosol-generating system according to example Ex52, wherein the aerosol-generating device comprises an external heating element located about the periphery of the device cavity.

Example Ex54: An aerosol-generating system according to example Ex52 or Ex53, wherein the aerosol-generating device comprises an internal heating element located in the device cavity and configured for insertion into the cartridge.

The invention will now be further described, by way of example only, with reference to the accompanying drawings in which:

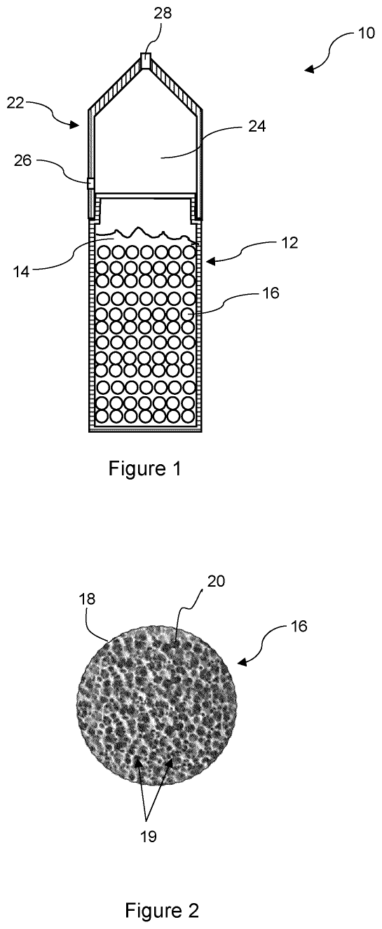

FIG. 1 shows a schematic cross-sectional view of a cartridge according to a first embodiment of the first aspect of the invention;

FIG. 2 shows a schematic magnified view of an aerosol-generating granule of the cartridge of FIG. 1;

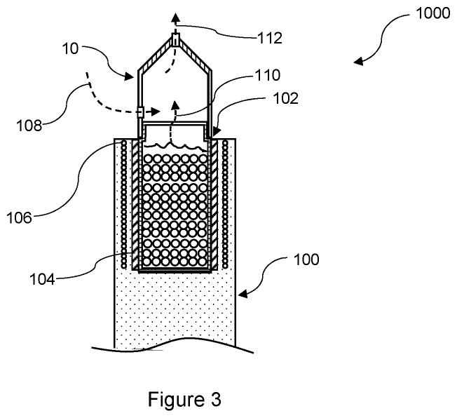

FIG. 3 shows a partial schematic cross-sectional view of an aerosol-generating system according to a first embodiment of the second aspect of the invention comprising the cartridge of FIG. 1 and an aerosol-generating device comprising an external heating element;

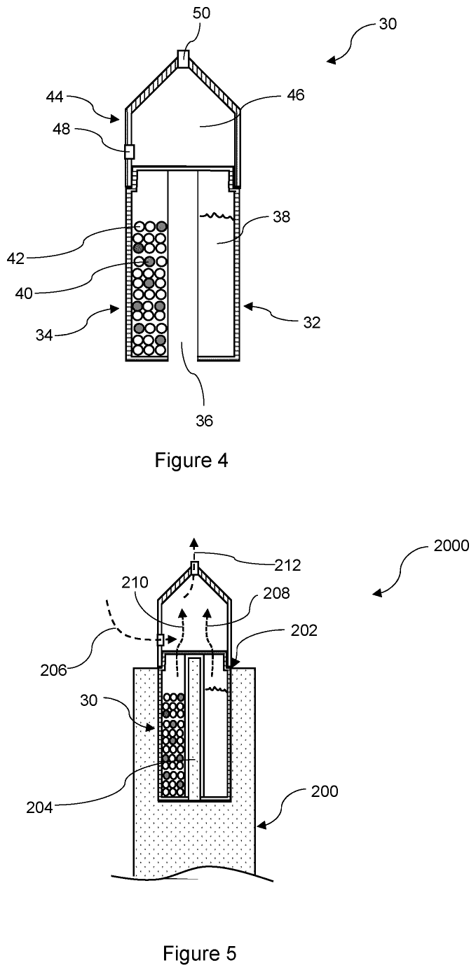

FIG. 4 shows a schematic cross-sectional view of a cartridge according to a second embodiment of the first aspect of the invention; and

FIG. 5 shows a partial schematic cross-sectional view of an aerosol-generating system according to a second embodiment of the second aspect of the invention comprising the cartridge of FIG. 4 and an aerosol generating device comprising an internal heating element.

FIG. 1 shows a schematic cross-sectional view of a cartridge 10 according to a first embodiment of the first aspect of the invention. The cartridge 10 comprises a cylindrical compartment 12 of substantially circular cross-section. The compartment 12 contains a first aerosol-generating substrate 14 and a plurality of aerosol-generating granules 16. The first aerosol-generating substrate 14 is a liquid. The plurality of aerosol-generating granules 16 are immersed within the first aerosol-generating substrate 14.

As shown in FIG. 2, the plurality of aerosol-generating granules 16 comprise a porous carrier medium 18 defining a plurality of pores 19 and a second aerosol-generating substrate 20 releasably retained within the pores 19 of the porous carrier medium 18. In FIGS. 1 and 2 the plurality of aerosol-generating granules 16 are shown as being substantially spherical in shape. However, it will be appreciated that the plurality of aerosol-generating granules 16 may have any suitable shape.

The cartridge 10 comprises a mouthpiece 22. The compartment 12 is separated from the mouthpiece 22 by a valve element (not shown). The valve element permits the flow of aerosol from the compartment 12 into the mouthpiece 22. The valve element prevents the flow of liquid from the compartment 12 into the mouthpiece 22. The mouthpiece 22 comprises a cooling chamber 24. The cooling chamber 24 comprises an air inlet 26 through which, in use, air can be drawn into the cartridge 10. The mouthpiece 22 comprises an air outlet 28 through which, in use, aerosol can exit the cartridge 10 for delivery to a user. The air outlet 28 is located at the proximal end of the mouthpiece 22.

FIG. 3 shows a schematic partial cross-sectional view of a handheld electrically operated aerosol-generating system 1000 according to a first embodiment of the second aspect of the invention comprising the cartridge 10 of FIG. 1 and an aerosol-generating device 100 configured to heat the first aerosol-generating substrate 14 and the second aerosol-generating substrate 20 contained in the compartment 12 of the cartridge 10.

The aerosol-generating device 100 comprises a housing defining a cylindrical device cavity 102 of substantially circular cross-section configured to receive the compartment 12 of the cartridge 10. The device cavity 102 has a closed distal end and an open proximal end. The compartment 12 of the cartridge 10 is inserted into the device cavity 102 of the aerosol-generating device 100 via the open proximal end of the device cavity 102. As shown in FIG. 3, the mouthpiece 22 of the cartridge 10 is not received in the device cavity 102 of the aerosol-generating device 100.

The aerosol-generating device 100 comprises an external heating element 104. The external heating element 104 is a susceptor element. The external heating element 104 is located about a periphery of the device cavity 102. The external heating element 104 circumscribes the compartment 12 of the cartridge 10 when the compartment of the cartridge 10 is received in the device cavity 102 of the aerosol-generating device 100.

The aerosol-generating device 100 comprises an inductor coil 106. The inductor coil 106 is located about a periphery of the device cavity 102 and circumscribes the external heating element 104. The aerosol-generating device 100 comprises a power supply in the form of a battery (not shown), such as a rechargeable lithium ion battery, and control circuitry (not shown) for controlling a supply of power from the battery to the inductor coil 106.

The aerosol-generating system 100 is configured so that once the compartment 12 of the cartridge 10 has been inserted into the device cavity 102 of the aerosol-generating device 100, a user can puff or draw on the mouthpiece 22 of the cartridge 10 to draw aerosol into their mouth through the air outlet 28 at the proximal end of the mouthpiece 22. In use, when a user puffs on the mouthpiece 22 of the cartridge 10, air is drawn into the cooling chamber 24 of the cartridge 10 through the air inlet 26 as indicated by arrow 108 and then through the cooling chamber 24 to the air outlet 28. The control circuitry of the aerosol-generating device 100 controls the supply of electrical power from the battery to the inductor coil 106 when the aerosol-generating system 1000 is activated. The control circuitry may include an airflow sensor (not shown) and the control circuitry may supply electrical power to the inductor coil 106 when user puffs are detected by the airflow sensor. This type of control arrangement is well known in aerosol-generating systems such as inhalers and e-cigarettes. The inductor coil 106 generates a fluctuating or alternating electromagnetic field in the device cavity 102. The fluctuating or alternating electromagnetic field produced by the inductor coil 106 induces eddy currents in the susceptor element causing the external heating element 104 to heat up. The first aerosol-generating substrate 14 and the plurality of aerosol-generating granules 16 contained in the compartment 12 of the cartridge 10 are heated by conductive heat transfer from the external heating element 104. This aerosolizes the first aerosol-generating substrate 14 and the second aerosol-generating substrate 20. The aerosolized first aerosol-generating substrate and the aerosolized second aerosol-generating substrate are drawn from the compartment 12 through the valve element into the cooling chamber 24 as indicated by arrow 110 where they are in entrained in the air drawn through the cooling chamber 24. The aerosolised first aerosol-generating substrate and the aerosolised second aerosol-generating substrate mix, cool and condense within the cooling chamber 24 to form an aerosol, which is then drawn into the user's mouth through the air outlet 28 as indicated by arrow 112.

FIG. 4 shows a schematic cross-sectional view of a cartridge 30 according to a second embodiment of the first aspect of the invention. The cartridge 30 comprises a first compartment 32 and a second compartment 34. The first compartment 32 and the second compartment 34 have a substantially semi-annular cross-section. The first compartment 32 and the second compartment 34 are disposed about a cylindrical cartridge cavity 36 of substantially circular cross-section. The cartridge cavity 36 is configured to receive an internal heating element of an aerosol-generating device as shown in FIG. 5.

The first compartment 32 contains a first aerosol-generating substrate 38. The first aerosol-generating substrate 38 is a gel.

The second compartment 34 contains a plurality of first aerosol-generating granules 40 and a plurality of second aerosol-generating granules 42. The plurality of first aerosol-generating granules 40 comprise a first porous carrier medium defining a plurality of pores and a second aerosol-generating substrate releasably retained within the pores of the first porous carrier medium. The plurality of second aerosol-generating granules 42 comprise a second porous carrier medium defining a plurality of pores and a third aerosol-generating substrate releasably retained within the pores of the second porous carrier medium. The plurality of first aerosol-generating granules 40 and the plurality of second aerosol-generating granules 42 are mixed within one another the second compartment 34. In FIG. 4 the plurality of first aerosol-generating granules 40 and the plurality of second aerosol-generating granules 42 are shown as being substantially spherical in shape. However, it will be appreciated that the plurality of first aerosol-generating granules 40 and the plurality of second aerosol-generating granules 42 may have any suitable shape.

The first porous carrier medium is the same as the second porous carrier medium.

The plurality of first aerosol-generating granules 40 and the plurality of second aerosol-generating granules 42 are not in contact with the first aerosol-generating substrate 38.

The first aerosol-generating substrate 38 has a different composition to the second aerosol-generating substrate. The first aerosol-generating substrate 38 has a different composition to the third aerosol-generating substrate. The second aerosol-generating substrate has a different composition to the third aerosol-generating substrate. The first aerosol-generating substrate 38 comprises nicotine and an aerosol former. The second aerosol-generating substrate comprises a first flavourant and an aerosol former. The third aerosol-generating substrate comprises a second flavourant and an aerosol former. The first flavourant is different to the second flavourant.

The cartridge 30 comprises a mouthpiece 44. The first compartment 32 and the second compartment 34 are each separated from the mouthpiece 44 by a valve element (not shown). The valve element permits the flow of aerosol from the first compartment 32 and the second compartment 34 into the mouthpiece 44. The valve element prevents the flow of liquid from the first compartment 32 and the second compartment 34 into the mouthpiece 44. The mouthpiece 44 comprises a cooling chamber 46. The cooling chamber 46 comprises an air inlet 48 through which, in use, air can be drawn into the cartridge 30. The mouthpiece 44 comprises an air outlet 50 through which, in use, aerosol can exit the cartridge 30 for delivery to a user.

FIG. 5 shows a schematic partial cross-sectional view of a handheld electrically operated aerosol-generating system 2000 according to a second embodiment of the second aspect of the invention comprising the cartridge 30 of FIG. 4 and an aerosol-generating device 200 configured to heat the first aerosol-generating substrate 38 contained in the first compartment 32 of the cartridge 30 and the second aerosol-generating substrate and the third aerosol-generating substrate contained in the second compartment 34 of the cartridge 30.

The aerosol-generating device 200 comprises a housing defining a cylindrical device cavity 202 of substantially circular cross-section configured to receive the first compartment 32 and the second compartment 34 of the cartridge 30. The device cavity 202 has a closed distal end and an open proximal end. The first compartment 32 and the second compartment 34 of the cartridge 30 are inserted into the device cavity 202 of the aerosol-generating device 200 via the open proximal end of the device cavity 202. As shown in FIG. 5, the mouthpiece 44 of the cartridge 30 is not received in the device cavity 202 of the aerosol-generating device 200.

The aerosol-generating device 200 comprises an internal heating element 204. The internal heating element 204 is a resistive heating element. The internal heating element 204 is in the form of a substantially cylindrical pin of substantially circular cross-section. The internal heating element 204 is located within the device cavity 202 and extends along a longitudinal axis of the device cavity 204. The internal heating element 204 is received in the cartridge cavity 36 of the cartridge 30 when the first compartment 32 and the second compartment 34 of the cartridge 30 are received in the device cavity 202 of the aerosol-generating device 200.

The aerosol-generating device 200 comprises a power supply in the form of a battery (not shown), such as a rechargeable lithium ion battery, and control circuitry (not shown) for controlling a supply of power from the battery to the internal heating element 204.

The aerosol-generating system 2000 is configured so that once the first compartment 32 and the second compartment 34 of the cartridge 30 have been inserted into the device cavity 202 of the aerosol-generating device 200, a user can puff or draw on the mouthpiece 44 of the cartridge 30 to draw aerosol into their mouth through the air outlet 50 at the proximal end of the mouthpiece 44. In use, when a user puffs on the mouthpiece 44 of the cartridge 30, air is drawn into the cooling chamber 46 of the cartridge 30 through the air inlet 48 as indicated by arrow 206 and then through the cooling chamber 46 to the air outlet 58. The control circuitry of the aerosol-generating device 200 controls the supply of electrical power from the battery to the internal heating element 204 when the aerosol-generating system 2000 is activated causing the internal heating element 204 to heat up. The control circuitry may include an airflow sensor (not shown) and the control circuitry may supply electrical power to the internal heating element 104 when user puffs are detected by the airflow sensor. This type of control arrangement is well known in aerosol-generating systems such as inhalers and e-cigarettes. The first aerosol-generating substrate 38 contained in the first compartment 32 of the cartridge 30 is heated by conductive heat transfer from the internal heating element 204. This aerosolizes the first aerosol-generating substrate 38. The aerosolized first aerosol-generating substrate is drawn from the first compartment 32 through the valve element into the cooling chamber 46 as indicated by arrow 208. The plurality of first aerosol-generating granules 40 and the plurality of second aerosol-generating granules 42 in the second compartment 34 of the cartridge 30 are also heated by conductive heat transfer from the internal heating element 204. This aerosolizes the second aerosol-generating substrate and the third aerosol-generating substrate. The aerosolized second aerosol-generating substrate and the aerosolized third aerosol-generating substrate are drawn from the second compartment 34 through the valve element into the cooling chamber 46 as indicated by arrow 210. The aerosolised first aerosol-generating substrate, the aerosolized second aerosol-generating substrate and the aerosolized third aerosol-generating substrate mix, cool and condense within the cooling chamber 46 to form an aerosol, which is then drawn into the user's mouth through the air outlet 50 as indicated by arrow 212.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10 percent of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention.

1-15. (canceled)

16. A cartridge for an aerosol-generating system, the cartridge comprising:
a compartment containing a first aerosol-generating substrate, wherein the first aerosol-generating substrate is a liquid or a gel; and
a plurality of aerosol-generating granules, wherein the plurality of aerosol-generating granules comprise a porous carrier medium defining a plurality of pores and a second aerosol-generating substrate releasably retained within the pores of the porous carrier medium, wherein the second aerosol-generating substrate is a liquid or a gel comprising a flavourant and an aerosol former,
wherein the compartment further contains the plurality of aerosol-generating granules, and
wherein some or all of the plurality of aerosol-generating granules are dispersed in the first aerosol-generating substrate.

17. The cartridge according to claim 16, wherein the first aerosol-generating substrate is a liquid and some or all of the plurality of aerosol-generating granules are immersed in the first aerosol-generating substrate.

18. The cartridge according to claim 16, wherein the first aerosol-generating substrate comprises nicotine and an aerosol former.

19. The cartridge according to claim 16, wherein the porous carrier medium comprises one or more of a ceramic, an igneous rock, and a sedimentary rock.

20. The cartridge according to claim 16, wherein the porous carrier medium comprises one or more of basalt, pumice, scoria, expanded clay, limestone, and sandstone.

21. The cartridge according to claim 16, wherein the plurality of aerosol-generating granules have a median particle size of between 0.1 millimetre and 3 millimetres.

22. The cartridge according to claim 16, wherein the plurality of aerosol-generating granules have a pore size of between 1 micrometre and 100 micrometres.

23. The cartridge according to claim 16, wherein the second aerosol-generating substrate has a lower aerosolization temperature than the first aerosol-generating substrate.

24. The cartridge according to claim 16,
wherein the plurality of aerosol-generating granules is a first plurality of aerosol-generating granules comprising a first porous carrier medium,
wherein the cartridge further comprises a second plurality of aerosol-generating granules comprising a second porous carrier medium defining a plurality of pores and a third aerosol-generating substrate releasably retained within the pores of the second porous carrier medium,
wherein the third aerosol-generating substrate is a liquid or a gel, and
wherein the second aerosol-generating granules are different from the first aerosol-generating granules.

25. The cartridge according to claim 24, wherein the second aerosol-generating substrate comprises a first flavourant and a first aerosol former, and the third aerosol-generating substrate comprises a second flavourant and a second aerosol former.

26. The cartridge according to claim 16, further comprising a mouthpiece.

27. The cartridge according to claim 26, wherein the mouthpiece comprises a cooling chamber.

28. An aerosol-generating system, comprising:
the cartridge according to claim 16; and
an aerosol-generating device configured to heat the first aerosol-generating substrate and the second aerosol-generating substrate.

29. The aerosol-generating system according to claim 28, wherein the aerosol-generating device comprises a housing defining a device cavity configured to receive at least a portion of the cartridge.

30. The aerosol-generating system according to claim 29, wherein the aerosol-generating device further comprises one or both of:
an external heating element located about the periphery of the device cavity, and
an internal heating element located in the device cavity and configured for insertion into the cartridge.
